(19) United States
(12) Patent Application Publication
(10) Pub. No.: US 2024/0070758 A1
(43) Pub. Date: Feb. 29, 2024

(54) SYSTEMS AND METHODS FOR A PROCUREMENT PROCESS

(71) Applicant: ROYAL BANK OF CANADA, Toronto (CA)

(72) Inventors: Natasha MEIKLE, Toronto (CA); Maiziel SERRAO, Toronto (CA); Akrash SHARMA, Toronto (CA); Mia TUSTANIC, Toronto (CA); Marsha COURTNEY, Toronto (CA); Mohammad Ammar, Toronto (CA)

(21) Appl. No.: 18/237,108

(22) Filed: Aug. 23, 2023

Related U.S. Application Data
(60) Provisional application No. 63/400,630, filed on Aug. 24, 2022.

(51) Int. Cl. G06Q 30/0601

(52) U.S. Cl. CPC G06Q 30/0637; G06Q 30/0641

(57) ABSTRACT

A procurement system allows a user to provide a request for goods or services. The request is processed to determine its complexity and, for high complexity cases, select an appropriate procurement professional using a trained classifier to handle the procurement request.

### RELATED APPLICATIONS

The current application claims priority to U.S. Provisional Application 63/400,630, filed Aug. 24, 2022 and titled “SYSTEMS AND METHODS FOR A PROCUREMENT PROCESS,” the entire contents of which are incorporated herein by reference in their entirety for all purposes.

### TECHNICAL FIELD

The current disclosure relates to procurement processes for businesses, and in particular to systems and methods for selecting and assigning a procurement request to a procurement professional.

### BACKGROUND

Large businesses typically have a procurement process in order to evaluate and approve or deny requests for goods and/or services. The procurement process is typically a relatively manual process between a business partner making the request and a procurement professional evaluating the request.

Current procurement processes may provide an undesirable user experience for individuals involved in the procurement process. Additionally, the process may result in delays in handling procurement requests as well as handling the request by individuals that may not have expertise in handling particular requests.

An additional, alternative, and/or improved process for handling procurement requests is desirable.

### BRIEF DESCRIPTION OF THE DRAWINGS

In the accompanying drawings, which illustrate one or more example embodiments:

FIG. 1 depicts a process for procurement of goods/services;

FIG. 2 depicts a process flow for procurement of goods/services;

FIG. 3 depicts a method of procuring goods/services; and

FIG. 4 depicts a process for procurement of goods/services.

### DETAILED DESCRIPTION

In accordance with the present disclosure there is provided a method for procuring goods or services comprising: receiving a procurement request from a user, the procurement request including details of goods or services being requested; determining a complexity of the procurement request; when the complexity of the procurement request is above a certain high complexity threshold, applying a trained classifier to the procurement request to identify a plurality of possible procurement professionals capable of handling the procurement request from a plurality of available procurement professionals; selecting a procurement professional from the plurality of possible procurement professionals based on a procurement workload of each possible procurement professional; and completing a procurement process between the user and the selected procurement professional.

In a further embodiment of the method, the method further comprises: presenting a plurality of initial questions to the user; and receiving responses to the plurality of initial questions, the responses providing the procurement request used to determine the complexity.

In a further embodiment of the method, the method further comprises: when the complexity request is above the certain threshold, presenting a plurality of follow-up questions to the user; and receiving follow-up responses to the plurality of follow-up questions, the follow-up responses added to the procurement request used to identify the plurality of possible procurement professionals.

In a further embodiment of the method, the method further comprises: when the complexity of the procurement request is below a low complexity threshold, presenting the user with self-serve procurement information.

In a further embodiment of the method, the method further comprises: when the complexity of the procurement request is between the low complexity threshold and the high complexity threshold, assigning the procurement request to an individual from a plurality of individuals capable of handling low complexity procurement requests, the individual selected based on workloads of the plurality of individuals.

In a further embodiment of the method, the classifier comprises one or more of: a decision tree classifier a random forest classifier; and an XGboost classifier.

In a further embodiment of the method, the method further comprises: adding one or more procurement professionals and their associated expertise to the plurality of available procurement professionals.

In a further embodiment of the method, the procurement process comprises: providing one or more detail questions from the selected procurement professional; receiving answers to the one or more detail questions from the user; and completing by the procurement professional the procurement request.

In a further embodiment of the method, the method further comprises: receiving an indication from the selected procurement professional that they are not able to handle the procurement request.

In a further embodiment of the method, the indication comprises one or more of: an indication that the workload of the selected professional is too high to complete the procurement request; and an indication that the selected professional is not capable of handling the procurement request.

In a further embodiment of the method, the indication that the selected professional is not capable of handling the procurement request comprises an indication of a different procurement professional for handling the procurement request.

In a further embodiment of the method, the indication of the different procurement professional is used as feedback to retrain the classifier.

In accordance with the present disclosure there is further provided a system for procuring goods or services comprising: a processor for executing instructions; and a memory storing instructions, which when executed by the processor configure the system to perform a method comprising: receiving a procurement request from a user, the procurement request including details of goods or services being requested; determining a complexity of the procurement request; when the complexity of the procurement request is above a certain high complexity threshold, applying a trained classifier to the procurement request to identify a plurality of possible procurement professionals capable of handling the procurement request from a plurality of available procurement professionals; selecting a procurement professional from the plurality of possible procurement professionals based on a procurement workload of each possible procurement professional; and completing a procurement process between the user and the selected procurement professional.

In a further embodiment of the system, the method performed by the system further comprises: presenting a plurality of initial questions to the user; and receiving responses to the plurality of initial questions, the responses providing the procurement request used to determine the complexity.

In a further embodiment of the system, the method performed by the system further comprises: when the complexity request is above the certain threshold, presenting a plurality of follow-up questions to the user; and receiving follow-up responses to the plurality of follow-up questions, the follow-up responses added to the procurement request used to identify the plurality of possible procurement professionals.

In a further embodiment of the system, the method performed by the system further comprises: when the complexity of the procurement request is below a low complexity threshold, presenting the user with self-serve procurement information.

In a further embodiment of the system, the method performed by the system further comprises: when the complexity of the procurement request is between the low complexity threshold and the high complexity threshold, assigning the procurement request to an individual from a plurality of individuals capable of handling low complexity procurement requests, the individual selected based on workloads of the plurality of individuals.

In a further embodiment of the system, the classifier comprises one or more of: a decision tree classifier a random forest classifier; and an XGboost classifier.

In a further embodiment of the system, the method performed by the system further comprises: adding one or more procurement professionals and their associated expertise to the plurality of available procurement professionals.

In accordance with the present disclosure there is further provided a non-transitory computer readable memory storing instructions, which when executed by a processor of a computing system configure the system to perform a method according to any of the methods described above. A procurement system is described further below that provides a single point of entry to the procurement process. This system simplifies the procurement process by evaluating a complexity of a procurement request in order to determine the appropriate way to handle the request. For example, for simple or relatively low complexity requests, the request may be self served, or sourced by the requesting individual. For more complex requests, the system can determine a plurality of possible procurement professionals to handle the request and then can assign the request to one of the possible procurement professionals. The system can provide an interface allowing the procurement professional and business partner of the request to determine the necessary information to complete the sourcing of the requested goods and/or services.

The system can provide an improved user-friendly interface for the business that allows full visibility of a request for procurement sourcing assistance, including details about the procurement professional the request has been assigned to. The system allows individuals to connect with procurement in an easy way will reduce compliance and operational risk to the organization. As a result, the business may be less likely to attempt bypassing the formal procurement process to source products and services on their own.

The system intakes complex sourcing requests and matches business partners directly with sourcing professionals who can fulfill that request to reduce the amount of time and energy on co-ordination. The system may present the business partner with a series of questions related to the request and then assigns a complexity score based on the responses given which will help with the accuracy of assignment and the balancing of workload among sourcing professionals. Once the solution matches a business partner with a sourcing professional, their request populates in a dashboard for both the business partner and the procurement professional giving full visibility of active and historical requests submitted as well as a full-page view showing the nature and details of the request.

The system may be hosted on a single platform and can provide a single procurement process across an entire enterprise to engage with procurement professionals. The centralized platform receives and collects request data and can provide reporting capabilities.

The system can provide an improved user interface and user experience to provide an easier and more efficient process for business partners to engage with sourcing, as well as for procurement professionals to track their workload. The system provides automatic assignment of requests using machine learning techniques to match business partners and sourcing professionals more efficiently. The system may include an analytics dashboard that can provide reports on request data, categories of requests, volumes throughout the year, etc. A request dashboard can provide visibility on the requests each user has submitted and an overview of the request such as if there are any outstanding questions or requests for the business partner to answer or provide. The dashboard may provide a full request view, both for the requesting business partner as well as the procurement professional and other individuals that may be involved in the procurement process. The dashboard can provide a full breakdown of all the data that comes with the request. The system uses a machine learning model, for example a Random Forest Classifier, to match sourcing professionals to business partners in order to complete a particular procurement request. The system uses the ML model to accurately match submitted requests with the most capable and possibly the most available sourcing professionals.

The system can provide various graphical user interfaces to view data within the system. For example, an active requests dashboard may provide a full overview of all active cases for both sourcing professional and business partners. The dashboard may provide users with the ability to see a quick overview of the case itself as well as pertinent tags that are of importance to the case itself.

A historical requests dashboard may provide a full overview of all previous cases submitted by a business partner or handled by a sourcing professional. Users can use the dashboard to see a quick overview of the case itself as any pertinent tags that were of important to the case during its lifecycle.

An analytics dashboard may provide a data visualization view available to select sourcing professionals to understand the current procurement landscape from a data perspective. The dashboard enables users to drill down on data visualizations by certain criteria such as fiscal year, line of business, category and sponsoring business unit.

An expertise dashboard may provide an editable interface for sourcing professionals to specify their capabilities, such as lines of businesses that they support as well as categories of products/services they are familiar with sourcing.

The system uses a ML matching algorithm that can use a multi-class classification algorithm that takes a set of responses submitted by a business partner, determines a number of professionals such as the top three most capable professionals by matching them on features such as the type of request, line of business, etc. The ML matching algorithm may use a random forest classifier to predict the top three most suitable sourcing professionals to handle the request then the sourcing professional with the lowest workload may be selected for handling the particular procurement request. Although a random forest classifier is described, it is possible to use other ML models to predict which procurement professionals are well suited to handle a particular request.

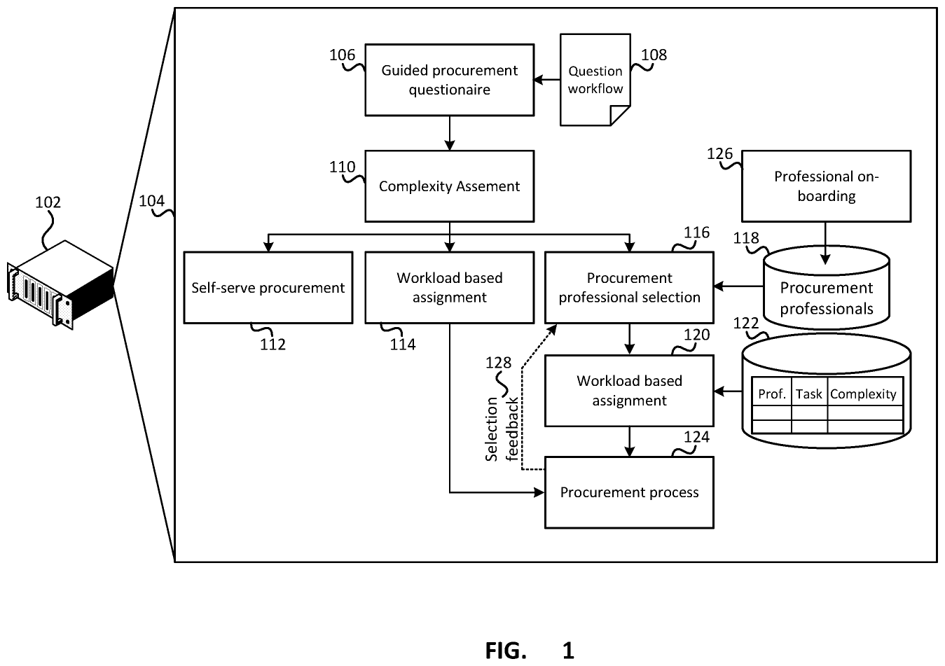

FIG. 1 depicts a process for procurement of goods/services. The system may be provided by one or more computing devices 102. Although not depicted explicitly in FIG. 1, the computing device 102 may contain one or more processors or microprocessors, such as a central processing unit (CPU). The CPU performs arithmetic calculations and control functions to execute software stored in a non-transitory internal memory, preferably random access memory (RAM) and/or read only memory (ROM), and possibly additional memory. The additional memory is non-volatile may include, for example, mass memory storage, hard disk drives, optical disk drives (including CD and DVD drives), magnetic disk drives, magnetic tape drives (including LTO, DLT, DAT and DCC), flash drives, program cartridges and cartridge interfaces such as those found in video game devices, removable memory chips such as EPROM or PROM, emerging storage media, such as holographic storage, or similar storage media as known in the art. This additional memory may be physically internal to the computer system, or both.

The one or more processors or microprocessors may comprise any suitable processing unit such as an artificial intelligence accelerator, programmable logic controller, a microcontroller (which comprises both a processing unit and a non-transitory computer readable medium), Al accelerator, system-on-a-chip (SoC). As an alternative to an implementation that relies on processor-executed computer program code, a hardware-based implementation may be used. For example, an application-specific integrated circuit (ASIC), field programmable gate array (FPGA), or other suitable type of hardware implementation may be used as an alternative to or to supplement an implementation that relies primarily on a processor executing computer program code stored on a computer medium.

The computer system may also include other similar means for allowing computer programs or other instructions to be loaded. Such means can include, for example, a communications interface (not shown) which allows software and data to be transferred between the computer system and external systems and networks. Examples of communications interface can include a modem, a network interface such as an Ethernet card, a wireless communication interface, or a serial or parallel communications port. Software and data transferred via communications interface are in the form of signals which can be electronic, acoustic, electromagnetic, optical or other signals capable of being received by communications interface. Multiple interfaces, of course, can be provided on a single computer system.

Input and output to and from the computer system may be administered by the input/output (I/O) interface (not shown). The I/O interface may administer control of the display, keyboard, external devices and other such components of the computer system. The computer system may also include a graphical processing unit (GPU). The GPU may also be used for computational purposes as an adjunct to, or instead of, the (CPU), for mathematical calculations.

The various components of the computer system may be coupled to one another either directly or by coupling to suitable buses. The term “computer system”, “data processing system” and related terms, as used herein, is not limited to any particular type of computer system and encompasses servers, desktop computers, laptop computers, networked mobile wireless telecommunication computing devices such as smartphones, tablet computers, as well as other types of computer systems.

The memory may store instructions which when executed by the processor, and possibly the GPU, configure the system to provide various functionality, including procurement functionality 104. The procurement functionality 104 include may include guided procurement questionnaire functionality 106 that presents the user making the procurement request with required questions throughout the process. The questions may be provided by a question workflow 108 that can indicate what questions to present during different stages of the process. For example, a first set of questions may be presented to the user in order to determine a complexity of the requests by complexity assessment functionality 110. Depending upon the determined complexity of the request, the question workflow 108 may provide different questions to the user.

Although the exact details of how the complexity of the procurement request is determined may vary with different business, one possibility is to present a number of questions whose answers contribute to a complexity score which can provide an indication of the complexity. For example the questions, answers and associated complexity scoring may include:
Question 1: What is the anticipated annual spend?)
Answers 1:
   $0 to $50,000 (complexity score=0)
   $50,001 to $1 MM (complexity score=1)
   >$1 MM (complexity score=2)
Question 2: Is the product/service a software solution or mobile application to be installed at the business or on a business device (mobile, desktop, laptop or server) or connect to the business network?
Answers 2:
   Yes (complexity score=1)
   No (complexity score=0)
Question 3: Are you outsourcing a function or service presently being performed by internal business team members?
Answers 3:
   Yes (complexity score=1)
   No (complexity score=0)
Question 4: Will the product/service interact directly with external clients?
Answers 4:
   Yes (complexity score=1)
   No (complexity score=0)
Question 5: Will the product/service require integration with business systems?
Answers 5:
   Yes (complexity score=1)
   No (complexity score=0)
Question 6: Will the product/service store data or permit electronic messaging outside of the business's network?
Answers 6:
   Yes (complexity score=1)
   No (complexity score=0)
Question 7: Will the information being shared be categorized as restricted, confidential, or sensitive?
Answers 7:
   Yes (complexity score=1)
   No (complexity score=0)

Based on the response to the complexity questions, the complexity score of the procurement request may be determined. The complexity score values associated with each answer are described as being either 0 or 1, although other values and ranges are possible. The complexity values of the answers provides an indication as to how the answer contributes to the complexity of the procurement request. Thresholds may be used in order to direct the further processing of the procurement request based on the determined complexity score. For example, for complexity scores below a low complexity threshold, for example a complexity score of 0-2, the procurement request may be suitable for self-servicing and the business partner submitting the request may be presented with self-serve procurement information such as best practices on completing the self-serve process, business rules for the procurement to be adhered to etc. It will be appreciated that the scores associated with low, medium, or high may vary, and additional or fewer different complexity levels may be provided. For example a low complexity request may be any request with a complexity score from the above questions of 0, while a medium or high is any request with a score of 1 or more.

If the procurement request is of a medium complexity, for example the complexity score is above the low complexity threshold but below a high complexity threshold, the request may be assigned to an individual based on workloads 114 of a plurality of individuals capable of handling the procurement requests. The individuals selected for processing these requests may not have particular expertise in procurement of the specific requests, however, since the procurement request is not of high complexity, it does not require particular expertise to source the requested goods/services. When completing the procurement process, additional questions about the specific procurement request may be presented to the business partner in order to facilitate completion of the procurement request by the assigned professional.

Although the above has described identifying various different levels of complexity, such as low, medium, and high and handling the procurement request according to the complexity, it is possible to handle the procurement request in other ways. For example, it is possible to identify only high and low complexities, with low complexities being handled in a self-serve process. The high complexity procurement requests may be handled by first filtering the requests based on qualities of the request. Based on the filtering, the request may then be handled either by assigning the request to individuals based on the individual's workload or by selecting a procurement professional based on a classification model as well as procurement professional workload. The filtering may be based on business criteria, rules, etc. For example, it may determine that all requests for goods/services above a certain monetary amount, related to certain business activities or lines of business, carried out in certain locals, etc. be handled by a procurement professional.

The above has described the complexity scores associated with answers as being either a 0 or 1. It is possible for different complexity scores to be provided. For example, the complexity score may vary based on the total estimated cost with costs below $50,000 being assigned a complexity score of 0, while those with a cost between $50,000 and $1 Million being assign a score between 0 and 1 weighted on the estimated cost, and for costs above $1 Million being assigned a score greater than 1 with the score weighted based on the total cost. It will be appreciated that various different weightings and scorings of the answers are possible. Such varying weightings provide for more control over complexity score. For example a request that with low complexity scores on all of the answers with a total value of the request of $10,000 should be treated as a low complexity request that can be completed using a self-serve process. However, if the same request had a total value in excess of $10 Million, it should be treated as high complexity regardless of the answers to other questions.

If the complexity assessment determines that the procurement request is of high complexity, the business partner may be guided to answer additional questions about the goods/services to be procured. For example, the additional questions may be provided from the question workflow 108 and presented to the user on the user interface. The questions may include one or more of:
Please include the Executive Sponsor(s) of this Request:
What product or service would you like to introduce to the business?
What is your sponsoring Business Unit?
What region is this product/service being delivered?
What is your business goal/need?
Is the introduction of this product/service related to a larger business project and/or initiative?
Have you identified a supplier who can deliver or perform the product or service required?
Have you considered using a Diverse supplier? Has a budget been allocated for this initiative?
Is the allocated spend in plan?
Will a Project Approval Request (PAR) be required?
Please attach any supporting information related to this request

Based on the request, a number, such as the top 3, of procurement professionals with particular expertise needed to complete the procurement request may be determined by procurement professional selection functionality 116. The procurement professional selection functionality may comprise a multi-class classifier that is trained to classify the request information into one of a plurality of classes with each class representing a procurement professional. Additionally, or alternatively the procurement professional selection functionality may use a recommendation model trained to recommend one or more professionals based on the request information. It will be appreciated that other ML models may be used to determine one or more procurement professionals suitable to handle a request. The available professionals, along with their experience and expertise may be stored in a database 118 and used to select a plurality of possible professionals for the request. Based on the possible professionals, one of the professionals may be selected using workload based functionality 120. The workload based assignment functionality may determine which of a plurality of professionals or individuals have capacity to complete the request in an acceptable time frame. The workload or availability of the professionals and or individuals may be stored in a database 122 which may be updated as requests are assigned and completed. Once the professional is assigned the procurement task procurement processing functionality 124 may be used to complete the required sourcing. The procurement processing functionality 124 may provide for an easy flow of communication between the requesting business partner and the procurement professional in order to complete the procurement process. It is possible that the selected professional may not wish to complete the requested procurement, in which case they selection may be reassigned. The selected professional may provide an indication of why the request was reassigned, such as not currently having the capacity, not having the expertise or there being another better suited professional. The information, and in particular indications that the selected professional was not right selection, may be provided as selection feedback 128 which can be used to re-train provided the procurement professional selection component 116.

The functionality 104 may also include professional on-boarding functionality 126 that allows a procurement professional to register with the system. The registration process may involve the professional to enter information about their expertise, experience and areas of work. The procurement professional selection component may be retrained in order to include any new individuals in the selection process.

The system uses machine learning to match business partners to sourcing professionals. Although various techniques are possible, one approach is to address the matching as a multi-class classification problem since the target variable, namely the procurement professional, may have a large number of classes such as over 50 or more possible procurement professional. In developing the classifier, first existing procurement data including information about the procurement request as well as the professional that handled the request, was cleaned. The cleaning includes filling in any missing data and consolidating inputs, then the dataset was explored by gauging the summary statistics. Next, for feature engineering, the categorical variables were encoded as binary values. Dummy variables were included such that each category was in binary (0 or 1). Next, since the total value amount variable may have a large range, for example from $0 to >1 MM$, the dataset was standardized. After standardization, the feature importance was gauged using Random Forest Feature Importance.

Finally, RandomizedSearchCV was used for hyperparameter tuning and then the model was trained with the best hyperparameters on 70% of the data. An F1 score and accuracy >70% was achieved on the test data set. It is noted that this initial training was performed using historical request data which did not include information about the particular business or type of requests that a particular professional handles. However, as this information is incorporated into the trained model, the performance of the model is expected to increase further since there will be a high correlation between features, such as the type of request the sourcing professional manages and the type of request the business partner submits. The system may also include a feature to reassign requests as well as a reason for reassignment. Thus, this information can be used to incrementally train the model, allowing the model to learn from past mistakes and improve with time since reassignment will have a negative correlation with sourcing professionals.

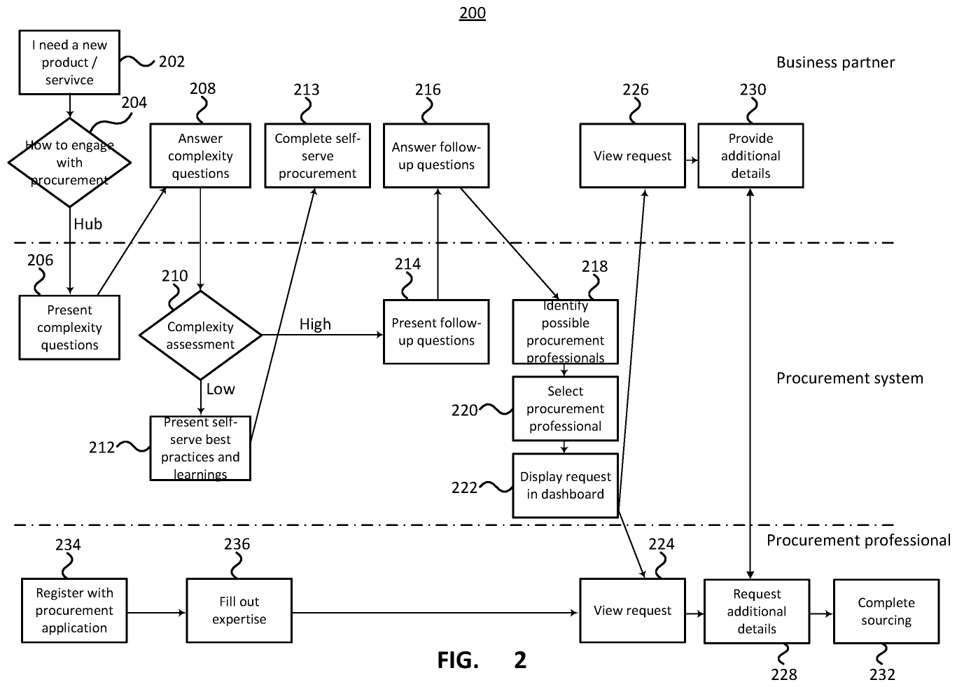

FIG. 2 depicts a process flow for procurement of goods/services. The process 200 may include actions performed by the business partners and procurement professionals as well as functionality automatically performed by the procurement system. The process may begin when a business partner determines that a new product or service is needed 202. The business partner may determine how best to engage with the procurement process 204. For example, they may know from previous experience that their request should be self-served, in which case they can proceed to complete the self-serve procurement.

If the business partner decides to engage with the procurement system, which may be accessed as a procurement hub or portal, the system presents the business partner with complexity questions 206 that are used to determine a complexity of the request. The business partner completes the complexity questions 208 and the system assesses the complexity based on the answers 210. For low complexity requests, the system may present the business partner with self-serve information such as best practices and learnings 212 and the business partner can complete the self-serve procurement process 213.

For high complexity requests, the system presents additional procurement questions to the business partner 214 and the business partner answers the questions 216. The answers to the questions are used to identify a number of possible procurement professionals 218 from a pool of available procurement professionals. The identification of the procurement professional attempts to identify the best professional for the procurement. Based on the number of possible procurement professionals, one is selected 220 to handle the request based on workloads of the professionals as well as other criteria possibly including user preferences, locality, etc. The selected professional is assigned the request and the system can display the request in a dashboard 222. The selected procurement professional may view the request 224, as well as the business partner 226. The system may facilitate communication between the parties in order to request additional details 228, and provide the requested details 230. Once all of the details are provided, the procurement professional may complete the requested sourcing 232.

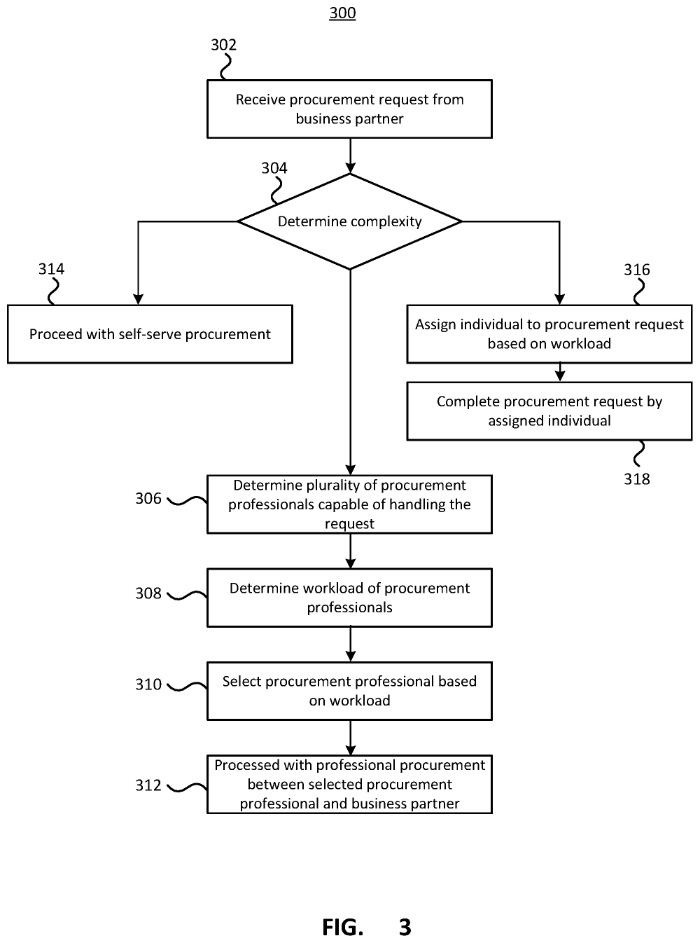

FIG. 3 depicts a method of procuring goods/services. The method 300 receives a procurement request from a business partner (302) that includes answers to one or more questions. Based on the request, a complexity of the request can be determined (304). If the complexity is determined to be high (High at 304), for example a determined numerical complexity score is above a high complexity threshold, additional questions about the request may be presented and answers received in order to determine a plurality of possible procurement professionals capable of handling the request (306). Once a number of professionals have been identified, the workload of the plurality of professionals may be determined (308) and used to select one of the professionals (310). The selected professional proceeds with the procurement process with the requesting business partner (312).

In addition to the high complexity request, the method may also determine that the request is a low complexity request (Low at 314) and proceed with completing in a selfOserving manner (316). If the complexity is an intermediate complexity, for example between the high and low complexity thresholds, the method may assign the request to an individual based on workloads of a plurality of individuals (318) capable of servicing basic procurement requests and the individual can complete the procurement request with the requesting business partner (320).

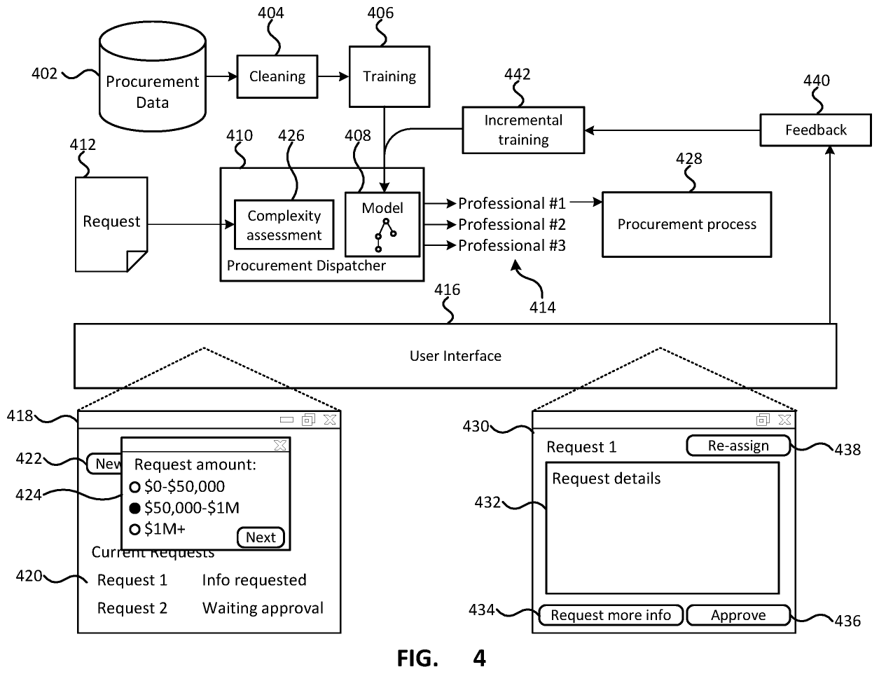

FIG. 4 depicts a process for procurement of goods/services. As depicted in FIG. 4, procurement data 402, comprising information on previous procurement requests including information about the professional that handled the request, can be provided to cleaning functionality 404 in order to standardize the data. The cleaning may include filling in missing data. The procurement data 402 may include historical data which may not include all relevant data, for example certain historical requests may not specify which line of business the request was related to, as well certain data may be incorrect. Additionally, the cleaning may encode categorical variables into binary values. For example, a variable that may have an answer selected from 3 options may be converted to 3 dummy variables each representing one of the options. The value of the dummy variable corresponding to the selected category can be set to 1, and the other dummy variable set to 0. Further, the cleaning may include normalizing certain values having a large range. The cleaned data may then be used by training functionality 406 that trains a model 408 of the procurement dispatcher functionality 410 that can suggest professionals to handle a procurement request. The model may comprise various different types of machine learning (ML) models including random forest multi-class classifiers as described above.

Once trained, the model 408 can be used to process a procurement request 412 and determine one or more professionals 414 that are suited for handling the request. A user making the procurement request 412 may use a user interface functionality 416 to complete one or more questions. As depicted, the user interface functionality may generate one or more graphical interfaces for presenting to users. The particular graphical interfaces, and the process flow between them, may vary. As an example, a graphical interface 418 may be presented as a web page that can display various information about current requests 420 including a current state of the request in the procurement process. The graphical interface may allow the user to click on one or more of the requests to view details, and possibly provide additional information requests by a procurement professional. The graphical interface 418 may allow a user to create a new request 422, which may present one or more questions 424 to the user. It will be appreciated that similar information and interactions can be presented in various different ways to the user.

Once an initial request is completed, for example by answering basic questions useful in determining a complexity of the request, the initial request may be provided to complexity assessment functionality 426 that determines a complexity of the request. Based on the determined complexity of the request, which may be determined based on scoring assigned to answers of the initial questions, the request can be passed to different functionality. For example, for simple requests, the request may be processed by self-serve functionality which allows the business user to process the procurement request themselves. For more complex requests, they may be assigned to a procurement professional based on the professional's workload. These requests may be simple enough that any professional is capable of handling them. For requests determined to be complex, it is desirable to assign an appropriate professional to handle the request. As such, the request 412 is applied to the trained model 408 which can provide a number of professionals 414 that would be suitable to handle the request. Prior to applying the request to the model, it is possible to obtain additional information from the business user regarding details about the request. The professional may then start the procurement process 428 with the user. The procurement process will depend upon the particular request, however the user interface 416 can provide a graphical interface 430 to the professional that is used for approving or denying the request. Part of the procurement process may comprise the professional reviewing details 432 of the request, evaluating the request, finding suppliers to fulfill the request, etc. In order to successfully evaluate the request the professional may require additional information from the user, and may request additional information 434 from the user which may return the request to the user for providing the requested information. The professional may use various tools or resources for completing the procurement request. Assuming that the request is eventually approved, the interface 430 can provide functionality for the professional to approve 436 the request.

It is possible that the selected professional is not well suited for completing the procurement request. For example, they may not have time to complete the request. Further, the professional may consider themselves unsuited to handle the particular details of the request, or may be aware of another professional that is better suited for the particular request. Re-assigning 438 the request to another professional may be used as feedback 440, which can be used to improve the model 408. The model 408 may be incrementally trained 442 using the feedback 440. In addition the feedback regarding reassignment of professionals, the user interface may allow a user to provide additional feedback such as an indication that the selected professional was a good selection, or possibly a bad selection.

In addition to incrementally training the model based on feedback, it is possible to periodically re-train 406 the model based on the procurement data. As new requests, and possibly professionals, are added to the system, the periodic retraining can help ensure the model is updated based on the most recent data.

Although not depicted in FIG. 4, the user interface may also allow a professional to specify details about their experience and expertise. For example, a list of possible areas of expertise can be presented to allow the professional to select those areas they have experience with. Similarly, the user interface may include indications of types of procurement requests the professional has handled in the past, possibly including an amount of the procurement requests.

The processor used in the foregoing embodiments may comprise, for example, a processing unit (such as a processor, microprocessor, or programmable logic controller) or a microcontroller (which comprises both a processing unit and a non-transitory computer readable medium). Examples of computer readable media that are non-transitory include disc-based media such as CD-ROMs and DVDs, magnetic media such as hard drives and other forms of magnetic disk storage, semiconductor based media such as flash media, random access memory (including DRAM and SRAM), and read only memory. As an alternative to an implementation that relies on processor-executed computer program code, a hardware-based implementation may be used. For example, an application-specific integrated circuit (ASIC), field programmable gate array (FPGA), system-on-a-chip (SoC), or other suitable type of hardware implementation may be used as an alternative to or to supplement an implementation that relies primarily on a processor executing computer program code stored on a computer medium.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference in the claims to “a challenge” or “the challenge” does not exclude embodiments in which multiple challenges are used). It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C” means “any one or more of A, B, and C”.

It is contemplated that any part of any aspect or embodiment discussed in this specification can be implemented or combined with any part of any other aspect or embodiment discussed in this specification.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

What is claimed is:

1. A method for procuring goods or services comprising:
receiving a procurement request from a user, the procurement request including details of goods or services being requested;
determining a complexity of the procurement request;
when the complexity of the procurement request is above a certain high complexity threshold, applying a trained classifier to the procurement request to identify a plurality of possible procurement professionals capable of handling the procurement request from a plurality of available procurement professionals;
selecting a procurement professional from the plurality of possible procurement professionals based on a procurement workload of each possible procurement professional; and
completing a procurement process between the user and the selected procurement professional.

2. The method of claim 1, further comprising:
presenting a plurality of initial questions to the user; and
receiving responses to the plurality of initial questions, the responses providing the procurement request used to determine the complexity.

3. The method of claim 2, further comprising:
when the complexity request is above the certain threshold, presenting a plurality of follow-up questions to the user; and
receiving follow-up responses to the plurality of follow-up questions, the follow-up responses added to the procurement request used to identify the plurality of possible procurement professionals.

4. The method of claim 1, further comprising:
when the complexity of the procurement request is below a low complexity threshold, presenting the user with self-serve procurement information.

5. The method of claim 4, further comprising:
when the complexity of the procurement request is between the low complexity threshold and the high complexity threshold, assigning the procurement request to an individual from a plurality of individuals capable of handling low complexity procurement requests, the individual selected based on workloads of the plurality of individuals.

6. The method of claim 1, wherein the classifier comprises one or more of:
a decision tree classifier
a random forest classifier; and
an XGboost classifier.

7. The method of claim 1, further comprising:
adding one or more procurement professionals and their associated expertise to the plurality of available procurement professionals.

8. The method of claim 1, wherein the procurement process comprises:
providing one or more detail questions from the selected procurement professional;
receiving answers to the one or more detail questions from the user; and
completing by the procurement professional the procurement request.

9. The method of claim 1, further comprising:
receiving an indication from the selected procurement professional that they are not able to handle the procurement request.

10. The method of claim 9, wherein the indication comprises one or more of:
an indication that the workload of the selected professional is too high to complete the procurement request; and
an indication that the selected professional is not capable of handling the procurement request.

11. The method of claim 10, wherein the indication that the selected professional is not capable of handling the procurement request comprises an indication of a different procurement professional for handling the procurement request.

12. The method of claim 11, wherein the indication of the different procurement professional is used as feedback to retrain the classifier.

13. A system for procuring goods or services comprising:
a processor for executing instructions; and
a memory storing instructions, which when executed by the processor configure the system to perform a method comprising:
receiving a procurement request from a user, the procurement request including details of goods or services being requested;
determining a complexity of the procurement request;
when the complexity of the procurement request is above a certain high complexity threshold, applying a trained classifier to the procurement request to identify a plurality of possible procurement professionals capable of handling the procurement request from a plurality of available procurement professionals;
selecting a procurement professional from the plurality of possible procurement professionals based on a procurement workload of each possible procurement professional; and
completing a procurement process between the user and the selected procurement professional.

14. The system of claim 13, further comprising:
presenting a plurality of initial questions to the user; and
receiving responses to the plurality of initial questions, the responses providing the procurement request used to determine the complexity.

15. The system of claim 14, further comprising:
when the complexity request is above the certain threshold, presenting a plurality of follow-up questions to the user; and
receiving follow-up responses to the plurality of follow-up questions, the follow-up responses added to the procurement request used to identify the plurality of possible procurement professionals.

16. The system of claim 13, further comprising:
when the complexity of the procurement request is below a low complexity threshold, presenting the user with self-serve procurement information.

17. The system of claim 16, further comprising:
when the complexity of the procurement request is between the low complexity threshold and the high complexity threshold, assigning the procurement request to an individual from a plurality of individuals capable of handling low complexity procurement requests, the individual selected based on workloads of the plurality of individuals.

18. The system of claim 13, wherein the classifier comprises one or more of:
a decision tree classifier
a random forest classifier; and
an XGboost classifier.

19. The system of claim 13, further comprising:
adding one or more procurement professionals and their associated expertise to the plurality of available procurement professionals.

20. A non-transitory computer readable memory storing instructions, which when executed by a processor of a computing system configure the system to perform a method according to claim 1.
